(19) United States
(12) Patent Application Publication
(10) Pub. No.: US 2003/0179541 A1
(43) Pub. Date: Sep. 25, 2003

(54) Double screen portable computer

(76) Inventor: Peter Sullivan, Short Hills, NJ (US)

Correspondence Address: Peter A. Sullivan, 214 Parsonage Hill Road, Short Hills, NJ, 07078, US

(21) Appl. No.: 10/104,798

(22) Filed: Mar. 21, 2002

(51) Int. Cl. G06F 1/16

(52) U.S. Cl. 361/681

(57) ABSTRACT

A double screen portable computer has a clamshell-type case containing a left side video screen and a right side video screen, at least one of which is touch or energy sensitive, said screens being connected to one or more CPUs, and said CPUs sharing other peripheral devices and communicating with each other, where the input device is a pen stylus, thus obviating the need for a keyboard.

This invention is in the field of personal computers, and more specifically a new type of portable personal computer arrangement.

### BACKGROUND OF THE INVENTION

The first generation of personal computer comprised an arrangement of a computer monitor, central processing unit (CPU) console and keyboard. The monitor's viewable surface was largely square and pixel orientation typically was biased in favor of horizontal. This arrangement, with some modification, is still the paradigm for the “desktop” computers.

The desktop computer was suitable for most applications (given the technological capability of the day) but did not allow for transportability. Thereafter, the computer industry created the portable or “laptop” computer. These computers were designed to be transportable from place to place and allowed users to take their work with them. The portable computer consisted of a “clamshell” case that contained a video screen on the top side and a keyboard on the other, bottom side.

The notebook computer satisfied the transportability function in some respects, but its video-on-keyboard design was inherently limiting for some applications. Hence, other, side-held devices, such as personal digital assistants, were created to sidele specific functions, such as calendar organizing and retrieving email, while other side-held devices were applied to industry-specific applications. The user was thus forced to purchase more than one device, depending on the application, and synchronize the devices in order for the data collected or created to be transferred to each other.

The desktop and laptop computer arrangement also was inherently limiting in performing multitasking functions in a practical way. In a graphical user interface environment such as Windows®, screens (or windows) representing different programs may be open at the same time, allowing the user to move from one program to another. This movement limits the user's ability to view multiple screens simultaneously because the active screen will overlay the other screens, blocking their view. If the screen is oriented to show two screens concurrently, invariably the cropping that takes place limits the actual viewable area for each screen. This limitation is a function of the screen size and, to a lesser degree, pixel density.

Moreover, some applications are performed clumsily in the current arrangement. For example, note-taking during classes is difficult for students who often need to balance a textbook next to the laptop to take notes. In some cases, the tap-tap-tap din of the keyboard is distracting to instructors, leading some to prohibit computer-based note-taking altogether. A computer that has a video display of a textbook and a note-taking surface that is not exclusively keyboard-driven would solve both the space and the noise problem. As another example, it is quite difficult to work on an airplane with a laptop computer while referring to another document. Again, an arrangement that allowed for electronic viewing of documents alongside a note-taking area would alleviate this problem.

Others have attempted different solutions to this problem. The IBM Thinkpad Transnote® is an arrangement of a laptop computer adjacent to an ordinary writing tablet. The pen for the writing tablet is a digital pen that records the movement along the paper and sends the data to the computer, where it is stored and displayed on the screen. Microsoft's Tablet PC® is essentially a letter paper-sized touch-screen computer tablet. Neither of these solutions offer the advantages of the invention here of dual screens that allow note-taking on one screen while refering to a second computer screen.

Other, as-yet undeveloped uses are also contemplated. A double screen video terminal would spur the use of e-books because it would provide a convenient portable viewing surface. Viewing electronically scanned photographic images also would be easier with such a portable viewing area.

Thus, it is an object of this invention to provide a portable computer that is adaptable to more applications than the current version of laptop computers.

It is a further object of the invention to provide a portable computer that greatly enhances the screen-viewing capability of the user.

It is a further object of the invention to provide a portable computer that is adaptable to still-evolving applications, such a electronic book viewing, and electronic photograph viewing, for which the current computers on the market are insufficient.

It is a further object of the invention to provide a portable computer that has in one device the ability to perform applications for which users currently purchase multiple devices.

It is a still further object of the invention to provide a portable computer that makes it easier for users to use two or more applications simultaneously.

Other objects of the invention will become apparent in reading the description set forth below.

The objects of the invention are achieved by a portable computer arrangement that includes a clamshell case having two integrally attached sides, each side containing a video screen. At least one of the computer screens can be activated by the touch of a stylus or the signal of a digital pen. In one embodiment, the computer will be powered by two processors and communicate with each other for shared peripherals, either using a shared bus or in an internal network arrangement. In another embodiment, the screens will be controlled by a single processor. Memory storage devices and other peripherals may be incorporated integrally to the computer arrangement or through input/output port connections.

### BRIEF DESCRIPTION OF THE DRAWINGS

FIG. 1 is a front view of the double screen portable computer of the invention.

FIG. 2 is a bottom view of the double screen portable computer of the invention.

FIG. 3 is another bottom view of the double screen portable computer of the invention.

FIG. 4 is a line diagram of the major components of the double screen portable computer according to one embodiment of the invention.

FIG. 5 is a line diagram of the major components of the double screen portable computer according to a second embodiment of the invention.

FIG. 6 is a line diagram of the major components of the double screen portable computer according to a third embodiment of the invention.

### DETAILED DESCRIPTION OF THE DRAWINGS

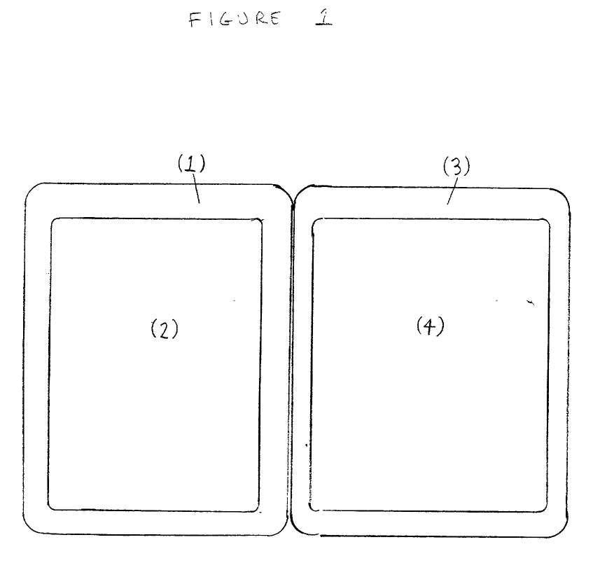

The double screen portable computer of FIG. 1 has a left side clamshell (1) which contains a left side video screen (2). Left side clamshell (1) is integrally connected, either pivotably connected or slidably connected, to a right side clamshell (3). In another embodiment, left side clamshell (1) is removably attached to right side clam shell (3). Right-side clamshell (3) contains a right side video screen (4). One or both of left side video screen (2) and right side video screen (4) may be touch or energy sensitive and may be manipulated by a pen stylus (5). The pen stylus may take the form of a digital pen.

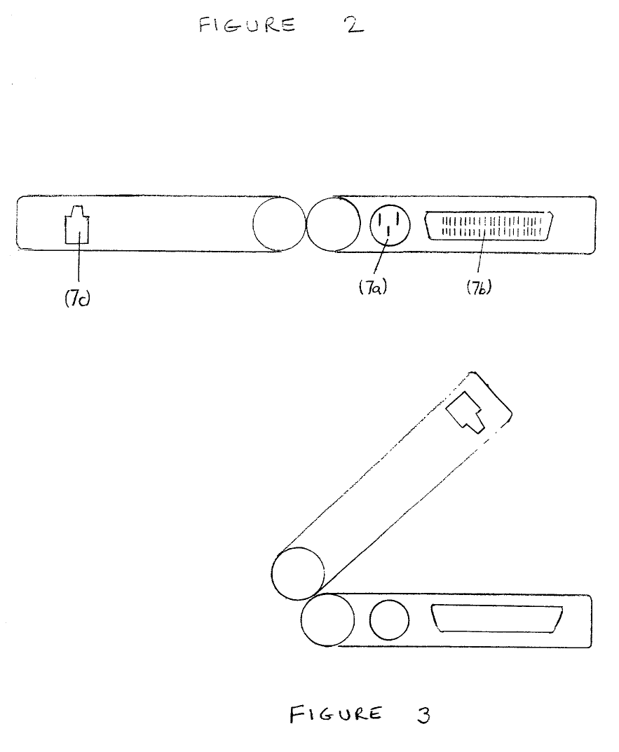

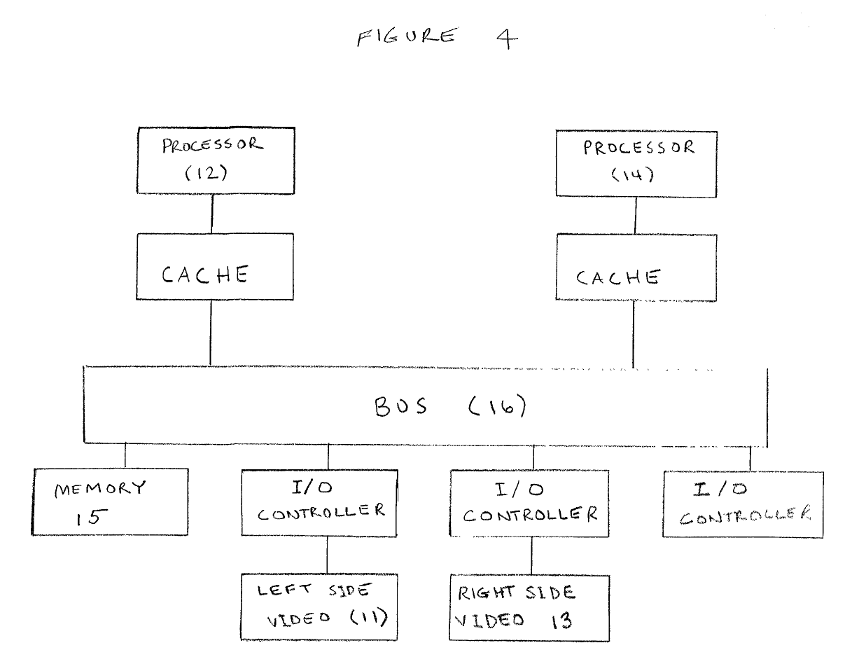

As shown in FIG. 2, the double screen portable computer opens and closes in a manner similar to laptop computers that are commercially available. Unlike laptop computers, however, the clamshell of the invention here is designed to open to 180° as shown in FIG. 3. The invention would be adapted to sit flat on a desk or table surface, or at a slight angle using supports (not shown). Peripherals may be plugged into ports (7a, 7b, and 7c) located at the bottoms of left side side clamshell (1) and right side side clamshell (3). Peripeherals may be plugged in individually or through a docking station.

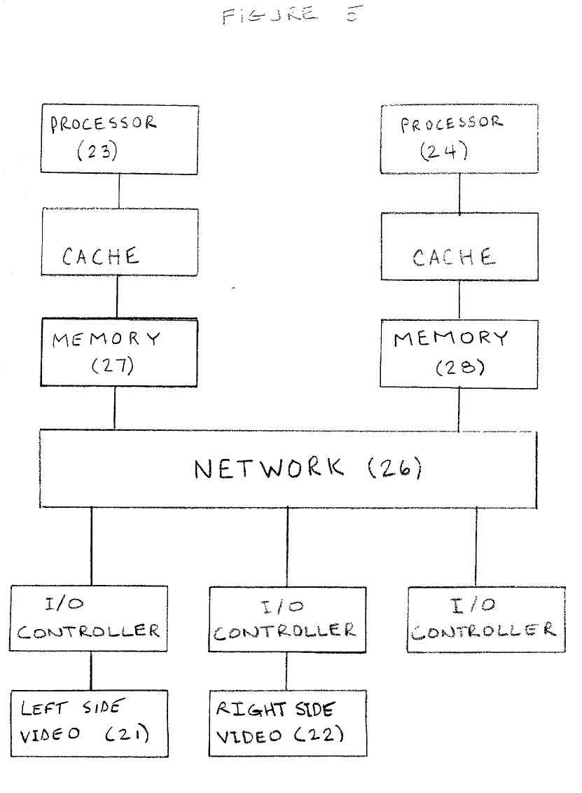

FIG. 4 is a diagram of the major components of the invention for a first embodiment. In this embodiment, a left side video output (11) is connected through a bus (16) to a first processor (12), and a right side video output (13) is connected by bus (16) to a second processor (14). First processor (12) and second processor (13) share a memory device (14) such as a hard drive, and peripherals such as a keyboard, mouse, external drive or a communications connection through bus 16. First processor (12) and second processor (13) also communicate directly to each other through bus (16), allowing for data exchange between the two computers. Left side processor (12) and right side processor (13) will each have its own random access memory (“RAM”) and video random access memory (“VRAM”) in one embodiment, but in other embodiments RAM and VRAM may be shared completely or partly between processors (12, 13).

In one embodiment, a trigger, such as a tap on a video screen with pen, will indicate which screen is active for accessing a shared memory device or peripherals at that point. In other embodiments, both screens will be active simultaneously and can be accessed through a touch, keyboard, mouse, or buttons integral to the computer arrangement. In addition, each processore will be able to access shared devices automatically according to a predetermined access-sharing algorithm for such software and operating system functions as auto-saves and system checks. The particular accessing algorithm is not a part of the invention and alternatives for this algorithm are known by those skilled in the art.

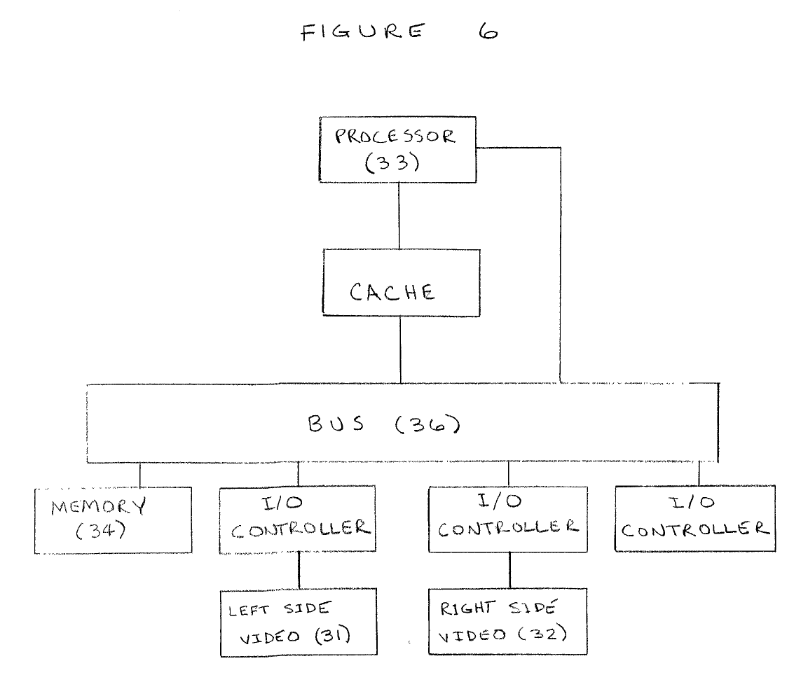

FIG. 5 is a diagram for another embodiment of the invention. In this embodiment, first processor 23 and second processor 24 each have separate memory devices (27, 28) and connect to left side video (21) and right side video (22) through network (26).

FIG. 6 is a diagram of the major components of the invention for another embodiment. Video outputs (31) and (32) are connected to a single processor (33), through bus (36). Bus (36) also controls a shared memory device (24) and other peripheral devices. The internal configuration of components in this embodiment is essentially the configuration of the prior art, except that in this embodiment here two separate video screens are active, rather than only one video screen being active as in the personal computers in the prior art. The system architecture choices are known in the art and do not affect the objects of the invention.

The above described invention is readily adapted to function as a writing-based personal computer without the need to use a keyboard. There are many advantages to having such an arrangement. Note-taking may take place on one video screen while simultaneously referring to the other video screen. In some configurations, character recognition software can convert the sidewriting into text, either in real time or in background, depending on the application. Even the physical size of the video screens can be varied according to consumer taste, ranging from a PDA comparable size (but with twice the viewable area of a PDA when opened), all the way up to full-size laptop screens. Screen size would only be limited by technology and consumer taste.

Other embodiments and configurations will become apparent to those skilled in the art after reviewing this description.

I claim:

1. A portable computer arrangement comprising
a left side clam shell containing a left side video screen;
a right side clam shell containing a right side video screen, at least one of either said left side video screen and said right side video screen adapted to be manipulated by a pen stylus, said left side clam shell being integrally attached to said right side clam shell;
a processing means for said left side video screen and said right side video screen; and
a connecting means for operatively connecting said processing means to said left side video screen and to said right side video screen.

2. The computer arrangement of claim 1, wherein said processing means comprises a single processing unit operatively attached to both of said video screens.

3. The computer arrangement of claim 1, wherein said processing means comprises at least two processing units, one of said processing units operatively attached to one of said video screens and a second of said processing units operatively attached to a second video screen.

4. The computer arrangement of claim 1, wherein said connecting means comprises a bus.

5. The computer arrangement of claim 1, wherein said connecting means comprises a network.

6. The computer arrangement of claim 1, wherein said left side clamshell is pivotably attached to said right side clam shell.

7. The computer arrangement of claim 1, wherein said left side clamshell is removably attached to said right side clam shell.

8. The computer arrangement of claim 2, wherein said processing means comprises at least two processing units, one of said processing units operatively attached to one of said video screens and a second of said processing units operatively attached to a second video screen.

9. The computer arrangement of claim 2, wherein said connecting means comprises a bus.

10. The computer arrangement of claim 2, wherein said connecting means comprises a network.

11. The computer arrangement of claim 2, wherein said left side clamshell is pivotably attached to said right side clam shell.

12. The computer arrangement of claim 2, wherein said left side clamshell is removably attached to said right side clam shell.

13. The computer arrangement of claim 3, wherein said processing means comprises at least two processing units, one of said processing units operatively attached to one of said video screens and a second of said processing units operatively attached to a second video screen.

14. The computer arrangement of claim 3, wherein said connecting means comprises a bus.

15. The computer arrangement of claim 3, wherein said connecting means comprises a network.

16. The computer arrangement of claim 3, wherein said left side clamshell is pivotably attached to said right side clam shell.

17. The computer arrangement of claim 3, wherein said left side clamshell is removably attached to said right side clam shell.

18. The computer arrangement of claim 4, wherein said left side clamshell is pivotably attached to said right side clam shell.

19. The computer arrangement of claim 4, wherein said left side clamshell is removably attached to said right side clam shell.

20. The computer arrangement of claim 5, wherein said left side clamshell is pivotably attached to said right side clam shell.

21. The computer arrangement of claim 5, wherein said left side clamshell is removably attached to said right side clam shell.
